(19) United States
(12) Patent Application Publication
(10) Pub. No.: US 2026/0257610 A1
(43) Pub. Date: Sep. 3, 2026

(54) NET ASSEMBLY FOR SECURING A LOAD ON A BED OF A TRUCK AND METHOD THEREFOR

(71) Applicant: Travis Webster, Middlebranch, OH (US)

(72) Inventor: Travis Webster, Middlebranch, OH (US)

(21) Appl. No.: 19/067,209

(22) Filed: Feb. 28, 2025

(51) Int. Cl. B60P 7/08

(52) U.S. Cl. CPC B60P 7/0876; B60P 7/0838

(57) ABSTRACT

A net assembly for securing a load on a bed of a truck includes a net, a plurality of coupler assemblies, and a plurality of tension hooks. The net includes a plurality of cords woven together. The net is rectangular with four corner portions. The net is positionable over an end portion of a load on a bed of a truck between the load and a cab of the truck. Each of the coupler assemblies is coupled to a respective one of the corner portions. Each of the coupler assemblies is elongated and extends from a respective one of the corner portions. Each of the tension hooks is designed to be coupled to a respective one of the coupler assemblies and to the bed of the truck. The tension hooks are adjustable to pull the net taut over the load to prevent sliding of the load into the cab.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cargo nets and more particularly pertains to a new net assembly for securing a load on a bed of a truck. In the trucking industry, there is a risk that a load on the bed of the truck, such as a flatbed trailer of a tractor trailer, could slide forward into the cab of the truck, such as during a sudden stop of the truck. The load, such as pipes, steel beams, or large pieces of wood, though secured, could be dislodged by the forces exerted during the sudden stop and propelled forward with great force into the cab, thereby risking damage to the cab and possibly the driver and any passengers. The new net assembly provides a way to secure the front of the load to prevent the load from sliding forward.

### (2) Description of Related Art Including Information Disclosed Under 37 CFR 1.97 and 1.98

The prior art relates to cargo nets. The prior art, as best understood, does not disclose a net assembly for securing a load on a bed of a truck that includes a net, a plurality of coupler assemblies, and a plurality of tension hooks. The net includes a plurality of cords woven together and is positionable over an end portion of a load on a bed of a truck between the load and a cab of the truck. Each of the coupler assemblies is coupled to a respective one of the corner portions. Each of the tension hooks is designed to couple the coupler assemblies to the bed of the truck. The tension hooks are adjustable to pull the net taut over the end portion the load to prevent sliding of the load into the cab of the truck. The prior art also does not disclose the method of placing the net between the cab and the load.

### BRIEF SUMMARY OF THE INVENTION

An embodiment of the disclosure meets the needs presented above in a net assembly for securing a load on a bed of a truck generally comprising a net, a plurality of coupler assemblies, and a plurality of tension hooks. The net includes a plurality of cords woven together. The net has a rectangular shape and four corner portions. The net is positionable over an end portion of a load on a bed of a truck between the load and a cab of the truck. Each of the coupler assemblies is coupled to a respective one of the corner portions. Each of the coupler assemblies is elongated and extends from a respective one of the corner portions. Each of the tension hooks is designed to be coupled to a respective one of the coupler assemblies. Each of the tension hooks is designed to be coupled to the bed of the truck. The tension hooks are adjustable to pull the net taut over the end portion the load to prevent sliding of the load into the cab of the truck.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a net assembly according to an embodiment of the disclosure.

FIG. 2 is a close up view of a portion of an embodiment of the disclosure.

FIG. 3 is a side view of an embodiment of the disclosure in use.

FIG. 4 is a front view of an embodiment of the disclosure in use.

FIG. 5 is a side view of an embodiment of the disclosure in use.

### DETAILED DESCRIPTION OF THE INVENTION

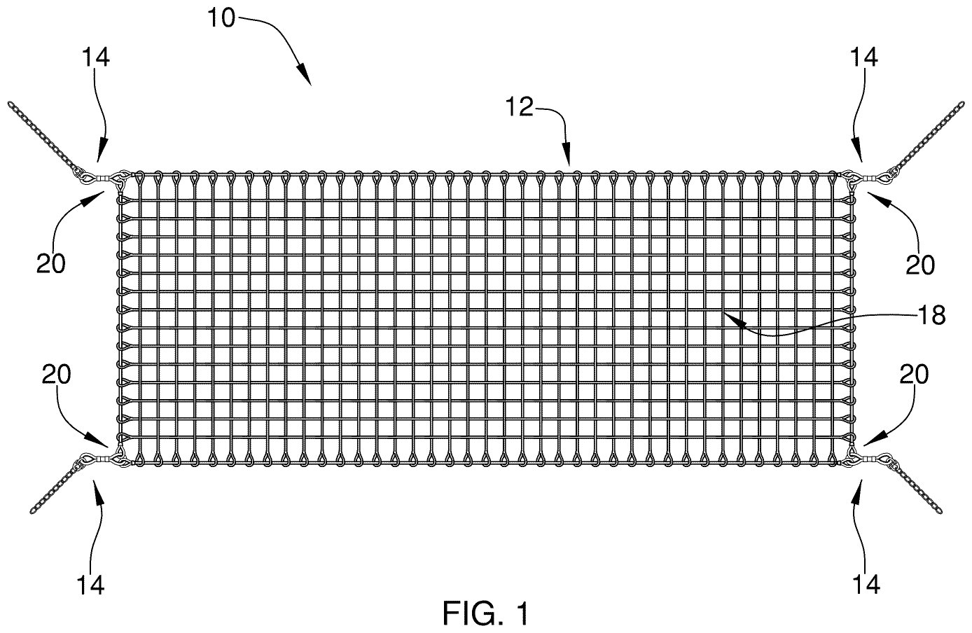

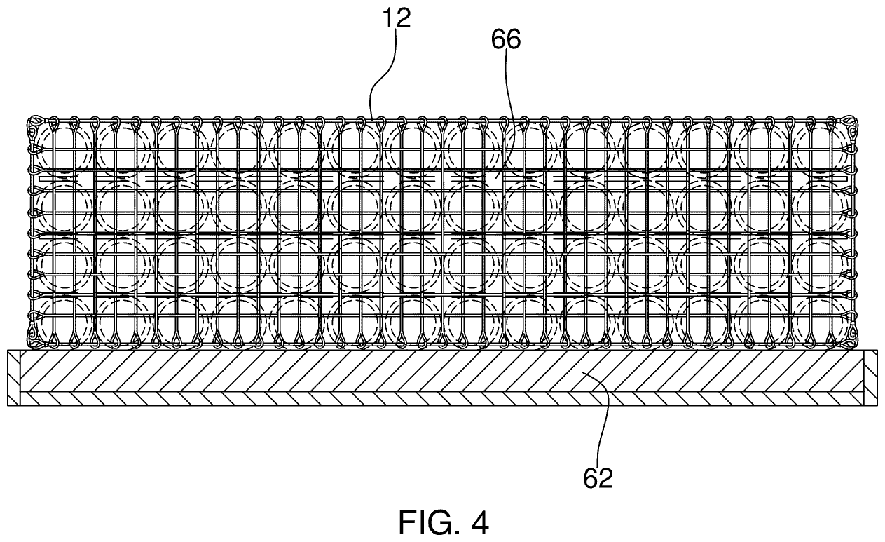

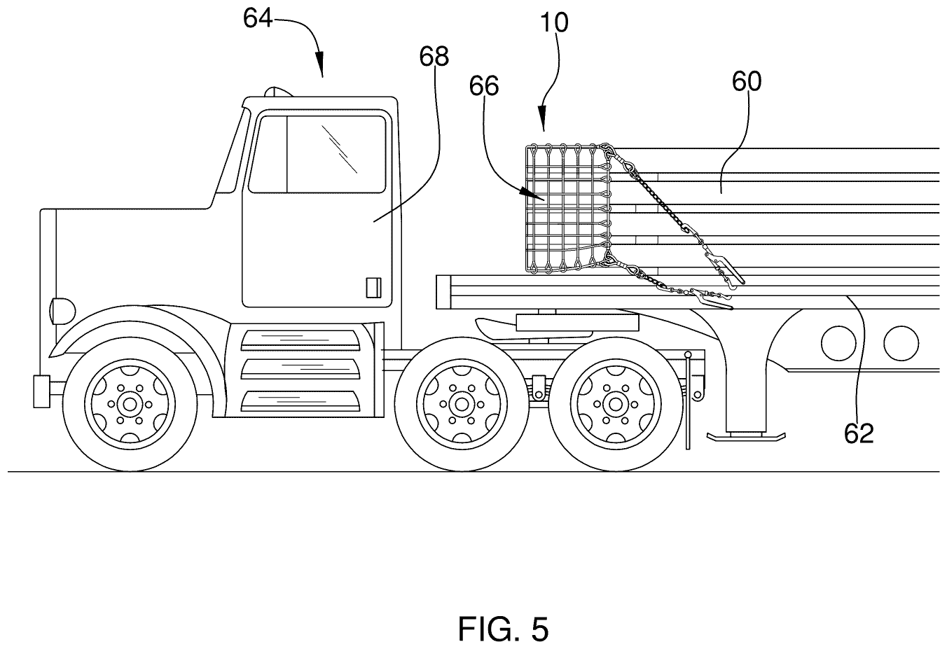

With reference now to the drawings, and in particular to FIGS. 1 through 5 thereof, a new net assembly embodying the principles and concepts of an embodiment of the disclosure and generally designated by the reference numeral 10 will be described.

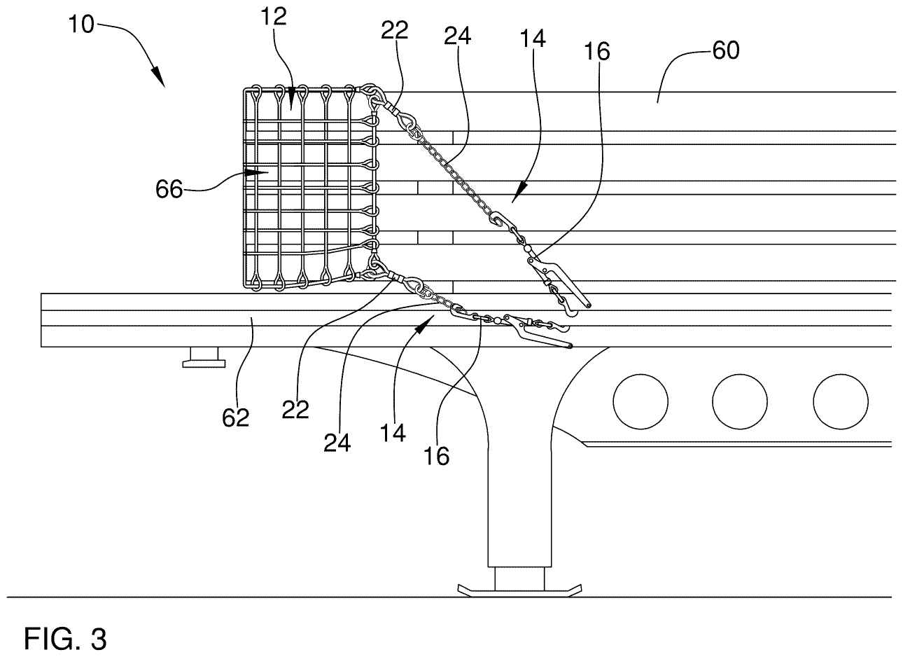

As best illustrated in FIGS. 1 through 5, the net assembly 10 for securing a load 60 on a bed 62 of a truck 64 generally comprises a net 12 and a plurality of coupler assemblies 14, shown in FIG. 1, and a plurality of tension hooks 16, shown in FIGS. 3 through 5. The net 12 includes a plurality of cords 18 woven together. The net 12 has a rectangular shape and four corner portions 20. As shown in FIGS. 3 through 5, the net 12 is positionable over an end portion 66 of a load 60 on a bed 62 of a truck 64 between the load 60 and a cab 68 of the truck 64. Each of the coupler assemblies 14 is coupled to a respective one of the corner portions 20. Each of the coupler assemblies 14 is elongated and extends from a respective one of the corner portions 20. Each of the tension hooks 16 is designed to be coupled to a respective one of the coupler assemblies 14. Each of the tension hooks 16 is designed to be coupled to the bed 62 of the truck 64. The tension hooks 16 are adjustable to pull the net 12 taut over the end portion 66 of the load 60 to prevent sliding of the load 60 into the cab 68 of the truck 64.

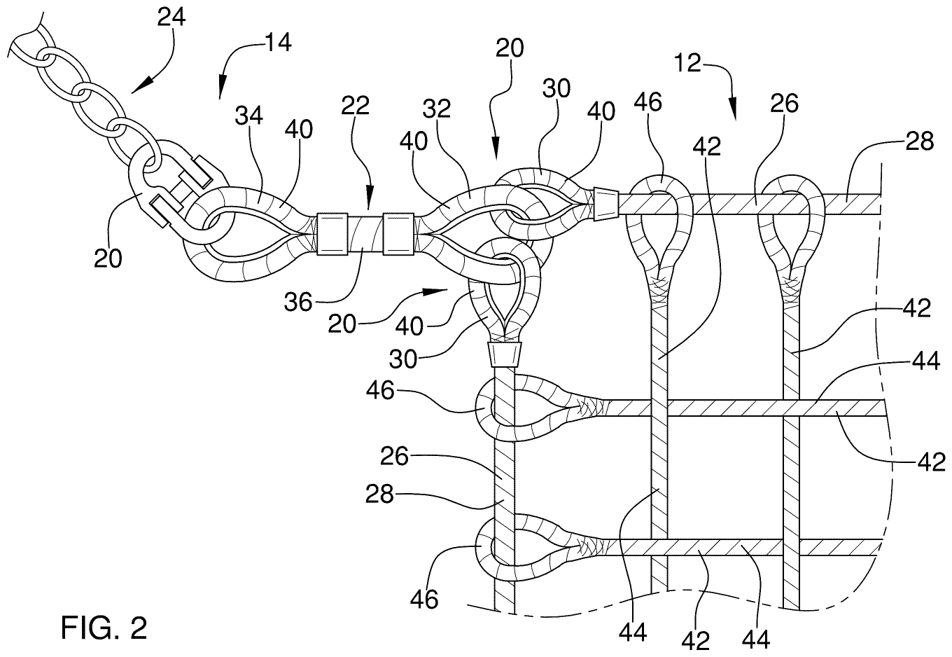

As best seen in FIG. 2, each of the coupler assemblies 14 includes a reinforced cable 22 and a chain 24. The reinforced cable 22 is coupled to a respective one of the corner portions 20 of the net 12. The chain 24 couples the reinforced cable 22 to a respective one of the tension hooks 16.

As shown in FIG. 1, the cords 18 include four perimeter cords 26 positioned at a perimeter of the net 12. Each of the perimeter cords 26 includes an elongated body 28 and a pair of closed loops 30 positioned one at either end of the elongated body 28. The reinforced cable 22 of each of the coupler assemblies 14 includes a first closed loop 32. As shown in FIG. 2, the first closed loop 32 of the reinforced cable 22 of each of the coupler assemblies 14 is interlocked with two of the closed loops 30 of the perimeter cords 26 positioned at a respective one of the corner portions 20 of the net 12. It should be understood that the figures show an exemplary embodiment, and that other designs and connections of the net 12 to the bed 62 of the truck 64 are within the scope of the disclosure.

The reinforced cable 22 includes a second closed loop 34 joined to the first closed loop 32 by a central body 36. Each of the coupler assemblies 14 includes a coupling link 38 interlocked with the chain 24 and the second closed loop 34 of the reinforced cable 22. The coupling link 38 can be made of metal, such as steel. The central body 36 of the reinforced cable 22 is short to provide greater strength at the reinforced cable 22 as most of the forces generated by the load 60 on the net 12 during a sudden stop would be concentrated at the corners of the net 12 and the reinforced cables 22.

In the exemplary embodiment, the net 12 further includes a plurality of metal thimbles 40. Each of the metal thimbles 40 is attached to a respective one of the first closed loop 32 and the second closed loop 34 of the reinforced cable 22 of each of the coupler assemblies 14 and a respective one of the closed loops 30 of each of the perimeter cords 26. The metal thimbles 40 provide reinforcement where the forces exerted by the load 60 will be greatest.

As shown in FIG. 1, the cords 18 include a plurality of interior cords 42 extending between the perimeter cords 26. Each of the interior cords 42 includes an elongated body 44 and a pair of closed loops 46 positioned one at either end of the elongated body 44 of each of the interior cords 42. Each of the closed loops 46 of each of the interior cords 42 is interlocked with the elongated body 28 of a respective one of the perimeter cords 26, as shown in close view in FIG. 2. In the exemplary embodiment, the interior cords 42 are interlaced or interwoven in a grid.

The reinforced cable 22 has a higher gauge than a gauge of the cords 18. The reinforced cable 22 can be metal wire. The cords 18 can be made of synthetic or metal fibers, or possibly fabric. The cords 18 could be resiliently stretchable to help increase the taut engagement. However, the stretchability should be limited to ensure the load 60 cannot slide forward.

The net 12 is rectangular in the exemplary embodiment, but could also be square or trapezoidal. The dimensions of the net 12 could be of any size, though the size should be suitable for loads 60 on the bed 62 of a truck 64, such as a tractor trailer. In one possible embodiment, the dimensions could be 8.0 to 11.0 feet by 3.0 to 5.0 feet, such as 9.5 feet by 4.0 feet.

To use the net assembly 10, as shown in FIGS. 3 through 5, a user positions the net 12 over an end portion 66 of the load 60 on the bed 62 of the truck 64 between the load 60 and the cab 68 of the truck 64. In the exemplary embodiment, the load 60 is a stack of pipes. The user couples each of the tension hooks 16 to a respective one of the coupler assemblies 14 and to the bed 62 of the truck 64. The user then adjusts the tension hooks 16 and thereby pulls the net 12 taut over the end of the load 60 to prevent sliding of the load 60 into the cab 68 of the truck 64. The tension hooks 16 could be of any known design, though in the exemplary embodiment the tension hooks 16 have a lever that can be pivoted to shorten the tension hook and lock the tension hook in place. The tension hooks 16 can be hooked to any link of the chain 24 as needed to achieve a taut connection of the net 12 with the load 60. If the driver must suddenly stop, the net assembly 10 will prevent the load 60 from sliding into the cab 68. When done transporting the load 60, the user can unlock the tension hooks 16 and remove the net assembly 10.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A net assembly for securing a load on a bed of a truck comprising:
a net, said net including a plurality of cords woven together, said net having a rectangular shape and four corner portions, said net being positionable over an end portion of a load on a bed of a truck between the load and a cab of the truck;
a plurality of coupler assemblies, each of said coupler assemblies being coupled to a respective one of said corner portions, each of said coupler assemblies being elongated and extending from a respective one of said corner portions; and
a plurality of tension hooks, each of said tension hooks being configured to be coupled to a respective one of said coupler assemblies, each of said tension hooks being configured to be coupled to the bed of the truck, said tension hooks being adjustable to pull said net taut over the end portion the load to prevent sliding of the load into the cab of the truck.

2. The net assembly of claim 1, wherein:
said cords include four perimeter cords positioned at a perimeter of said net; and
each of said perimeter cords includes an elongated body and a pair of closed loops positioned one at either end of said elongated body.

3. The net assembly of claim 2, wherein:
said cords include a plurality of interior cords extending between said perimeter cords;
each of said interior cords includes an elongated body and a pair of closed loops positioned one at either end of said elongated body of each of said interior cords; and
each of said closed loops of each of said interior cords being interlocked with said elongated body of a respective one of said perimeter cords.

4. The net assembly of claim 1, wherein each of said coupler assemblies includes:
a reinforced cable coupled to a respective one of said corner portions; and
a chain coupling said reinforced cable to a respective one of said tension hooks.

5. The net assembly of claim 4, wherein:
said cords include four perimeter cords positioned at a perimeter of said net;
each of said perimeter cords includes an elongated body and a pair of closed loops positioned one at either end of said elongated body;
said reinforced cable of each of said coupler assemblies includes a closed loop; and
said closed loop of said reinforced cable of each of said coupler assemblies is interlocked with two of said closed loops of said perimeter cords positioned at a respective one of said corner portions of said net.

6. The net assembly of claim 5, wherein:
said closed loop of said reinforced cable is a first closed loop;
said reinforced cable includes a second closed loop joined to said first closed loop by a central body; and
each of said coupler assemblies includes a coupling link interlocked with said chain and said second closed loop of said reinforced cable.

7. The net assembly of claim 6, further comprising a plurality of metal thimbles, each of said metal thimbles being attached to a respective one of said first closed loop and said second closed loop of said reinforced cable of each of said coupler assemblies and a respective one of said closed loops of each of said perimeter cords.

8. The net assembly of claim 7, wherein:
said cords include a plurality of interior cords extending between said perimeter cords;
each of said interior cords includes an elongated body and a pair of closed loops positioned one at either end of said elongated body of each of said interior cords; and
each of said closed loops of each of said interior cords being interlocked with said elongated body of a respective one of said perimeter cords.

9. The net assembly of claim 8, wherein said reinforced cable has a higher gauge than a gauge of said cords.

10. A method of securing a load on a bed of a truck, said method comprising the steps of:
providing a net assembly comprising:
a net, said net including a plurality of cords woven together, said net having a rectangular shape and four corner portions, said net being positionable over an end portion of a load on a bed of a truck between the load and a cab of the truck;
a plurality of coupler assemblies, each of said coupler assemblies being coupled to a respective one of said corner portions, each of said coupler assemblies being elongated and extending from a respective one of said corner portions; and
a plurality of tension hooks, each of said tension hooks being configured to be coupled to a respective one of said coupler assemblies, each of said tension hooks being configured to be coupled to the bed of the truck, said tension hooks being adjustable to pull said net taut over the end portion the load to prevent sliding of the load into the cab of the truck;
positioning said net over an end portion of a load on a bed of a truck between the load and a cab of the truck;
coupling each of said tension hooks to a respective one of said coupler assemblies and to the bed of the truck; and
adjusting said tension hooks and thereby pulling said net taut over the end portion the load to prevent sliding of the load into the cab of the truck.

11. The method of claim 10, wherein each of said coupler assemblies includes a reinforced cable coupled to a respective one of said corner portions and a chain coupling said reinforced cable to a respective one of said tension hooks, and said step of coupling each of said tension hooks to a respective one of said coupler assemblies includes hooking said tension hook into a link of said chain.
